(19) United States
(12) Patent Application Publication
(10) Pub. No.: US 2007/0299633 A1
(43) Pub. Date: Dec. 27, 2007

(54) Data processing system

(75) Inventor: Naoki Ohsaka, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Nakagyo-ku (JP)

(21) Appl. No.: 11/812,548

(22) Filed: Jun. 20, 2007

(30) Foreign Application Priority Data
Jun. 21, 2006 (JP) 2006-170812

(51) Int. Cl. G06F 11/00; G06F 15/16; G06F 17/00

(52) U.S. Cl. 702/188; 715/513; 709/206

(57) ABSTRACT

The present invention provides a data processing system by which users can check the detailed analysis result wherever they are as long as they are in an environment capable of viewing an HTML mail. In a data processing apparatus, when a chromatogram is created based on the data collected by the LC, the image file creator creates a PNG file, and the image file registering processor stores the file in the image file storage in the web server. Next, the HTML file creator creates a report of the analysis result as an HTML document in which the PNG file is embedded, and the e-mail sending processor sends the HTML document to the predetermined address as an e-mail. When the e-mail is opened on a client terminal which has received the e-mail, the PNG file is downloaded from the web server and the analysis result report on which the PNG file is pasted is displayed.

The present invention relates to a data processing system for obtaining an analysis result by processing data of an analysis which was carried out with a liquid chromatograph, gas chromatograph, mass spectrometer, spectral photometer or similar analyzing apparatus.

### BACKGROUND OF THE INVENTION

In recent years, general-purpose computers (PCs) are often used for data processing and for controlling analyzing apparatuses such as a liquid chromatograph, gas chromatograph, mass spectrometer and spectral photometer. On these PCs, a dedicated controlling/processing software is installed, and by running the software, it is possible to control an apparatus concerned and process the obtained data. For example, when chromatogram data is obtained by a liquid chromatograph, a data processing apparatus, which is a PC running the dedicated software, produces one or more chromatograms based on the obtained data, and then performs a quantitative analysis or qualitative analysis by processing these chromatograms. The analysis result obtained by the data processing can be checked on the PC which has performed the data processing. The same analysis result can also be checked on other PCs (client terminals) if the system is configured as a client-server architecture. Basically, in order to view the analysis result from the client terminals, it is a prerequisite that the dedicated controlling/processing software is installed on each of the PCs.

When, for example, performing an automated analysis by a liquid chromatograph, it often takes a long time to finish the analysis. Hence, analyses are sometimes performed during night hours with very little supervision. Therefore, it is common for a person or persons in charge to leave the analyzing apparatus or go out while an analysis is being performed. Although there have been many demands for checking the analysis result with an external PC which is not included in the above-described client-server configuration, a dedicated controlling/processing software is not generally installed on such an external PC, and, in addition, accessing the analysis result from an external PC to a data processing apparatus via a network is unfavorable because of security reasons. As a consequence, the environment in which an analysis result as described earlier can be checked from anywhere with one normal PC is not yet realized.

On the other hand, conventionally, sending various information on an analysis to a predetermined client by using a function of an e-mail system is in operation. On apparatuses disclosed in Patent Documents 1, 2 or 3, for example, a mailing function of an e-mail system is built on. When an analysis is finished or some sort of problems have occurred, the apparatus automatically creates an e-mail to inform the situation and send it to a predetermined e-mail address. By using this function of the e-mail system, it is also possible to send information on an analysis result, and it is additionally possible to check the analysis result from any environment where e-mails can be received.

With these conventional apparatuses, it is possible, for example, to notify a simple analysis result as disclosed in FIG. 3 and paragraphs 0016 and 0017 of Patent Document 1. However, it is not possible to obtain a detailed analysis result containing a chromatogram image for example, which can be viewed on the data processing apparatus.

Patent Document 1: Japanese Unexamined Patent Application Publication No.10-215494

Patent Document 2: Japanese Unexamined Patent Application Publication No.10-308737

Patent Document 3: Japanese Unexamined Patent Application Publication No.11-122276

### SUMMARY OF THE INVENTION

To solve the above-mentioned problems, the present invention aims at providing a data processing system for easily checking a detailed analysis result using a personal computer with no dedicated application software at a place distant from analyzing apparatuses and their data processing apparatus.

Thus, the present invention provides a data processing system for receiving analysis data from one or plural analyzers connected to a network, for processing the analysis data and for producing an analysis result from the processed analysis data, the system comprising:

a) a report producing means for producing a report of the analysis result as an HTML document;

b) an image storing means for storing an image or images included in the HTML document and for providing the image or images responsive to an access via the network; and

c) an e-mail means for sending an e-mail of the HTML document to a predetermined address,

whereby the HTML document with the image or images can be viewed on a client terminal which has received the e-mail via the network.

In a data processing system according to the present invention, a report producing means, an image storing means and an e-mail means can be included in one apparatus (i.e. a computer). Or, an image storing means, for example, can be included in a web server which is realized by a computer that differs from a computer which includes a report producing means and an image storing means. In this case, images are sent and received via an intercommunication network.

In one aspect of the present invention, the analyzer is a chromatograph and the image is a chromatogram.

In the data processing system according to the present invention, a chromatogram is produced based on data obtained by a chromatograph, and the chromatogram is processed for quantitative analysis and/or qualitative analysis. After obtaining such an analysis result, the report producing means produces a report of the analysis result as an HTML document. In an HTML document, image or images are embedded as link information of the storage location of the image file. Therefore, registered addresses in the image storing means are embedded in the HTML document that is produced by the report producing means. When the image storing means is a web server, the registered address is a URL. The e-mail means sends this HTML document as an e-mail to a predetermined e-mail address. Accordingly, so-called an HTML mail is sent.

The e-mail is received via a mail server by a certain client terminal which is connected to the network. On the client terminal, an HTML mail compliant e-mail software (mailer software) is installed. When viewing the e-mail on the e-mail software, the e-mail software requests the image storing means, which stores images, to send image or images according to the HTML description, and the image storing means sends the image or images in response to the request. Consequently, the image or images are downloaded to the client terminal and a report with the image or images pasted on designated areas is shown on a monitor of the client terminal.

The network can be either an intranet or internet.

The image can be of any format. However, in order to be viewed with the most common HTML mail compliant e-mail software, PNG (Portable Network Graphics) format, GIF (Graphic Interchange Format) format or the like are suitable. For displaying the image with expandability, (e.g. enlarging the image), at the viewing end, a vector image format such as SVG (Scalable Vector Graphics) format is suitable. In this case, a software which can open files of this kind is needed to be installed on a client terminal.

With the data processing system according to an aspect of the present information, a person in charge of an analysis can check a detailed analysis result which contains an image or images of chromatogram for example wherever he/she is, as long as he/she is in an environment capable of viewing an HTML mail even though he/she does not have a computer with a dedicated software installed. If the e-mail is sent to plural destination e-mail addresses, intended analysis results can be viewed simultaneously on plural client terminals which are separated from each other. Since the image storing means is accessed when a sent e-mail is viewed, it is possible to confirm whether a report sent as an e-mail is viewed or not by monitoring accesses on the side of the image storing means.

### BRIEF DESCRIPTION OF THE DRAWINGS

FIG. 1 is an overall block diagram of an embodiment of an LC analyzing system.

FIG. 2 is a flowchart showing operations of the data processing apparatus in FIG. 1

FIG. 3 is an example of a display image for viewing an e-mail received at a client terminal.

### EXPLANATION OF NUMERALS

1 . . . Analyzing Component

11 . . . Liquid Chromatograph (LC)

12 . . . Data Processing Apparatus

13 . . . Image File Creator

14 . . . HTML File Creator

15 . . . Image File Registering Processor

16 . . . E-mail Sending Processor

2 . . . Web Server

21 . . . Image File Storage

22 . . . File Read-Write Processor

23 . . . Access Processor

3 . . . Sending Mail Server

4 . . . Intranet

5 . . . Internet

6 . . . Client Terminal

61 . . . HTML Mail Compliant E-mail Software

### DETAILED DESCRIPTION OF PREFERRED EMBODIMENTS

A liquid chromatograph (LC) analyzing system which is an embodiment of a data processing system according to the present invention is described with reference to figures.

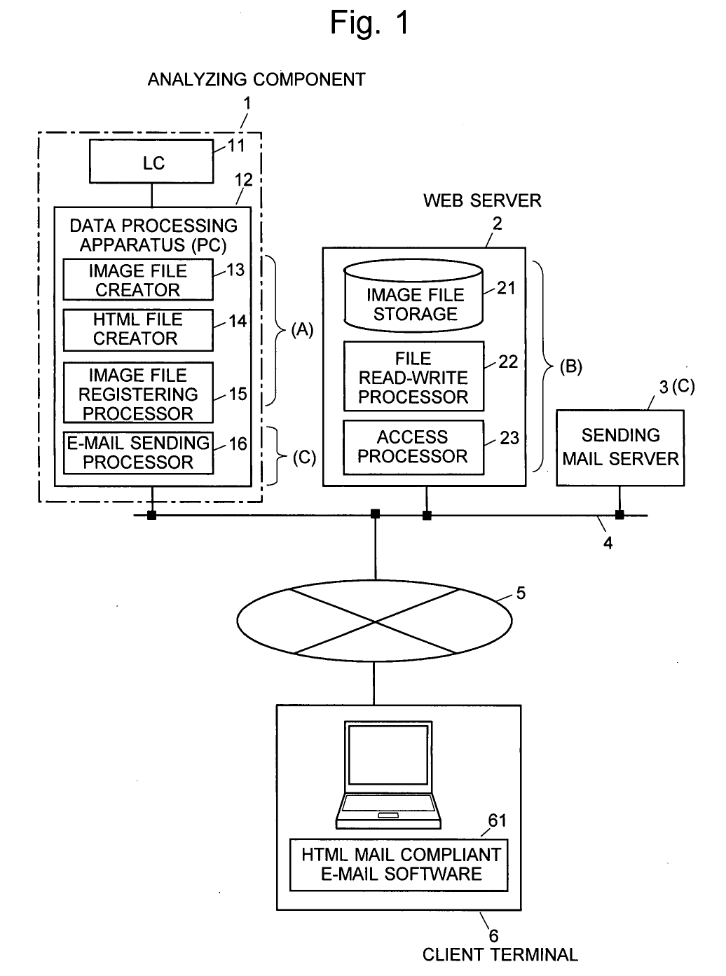

FIG. 1 is an overall block diagram of an LC analyzing system according to the embodiment. In the LC analyzing system, an analyzing component 1, a web server 2 and a sending mail server 3 are connected to an intranet 4 which is closed in a company for example. The intranet 4 is connected to the outside internet 5 via a firewall (not shown) or the like. A client terminal 6 is connected to the internet 5.

The analyzing component 1 includes an LC 11 for performing an LC analysis of a sample to collect data and a data processing apparatus 12 for receiving the data obtained by the LC 11 and for performing a predetermined data processing. The data processing apparatus 12 is realized by a personal computer (PC), and by executing a dedicated application software installed on the computer, functions of components such as an image file creator 13, an HTML file creator 14, an image file registering processor 15 and an e-mail sending processor 16 are realized in addition to the normal data processing function.

The web server 2 is a computer with a dedicated application software installed, and comprises an image file storage 21, a file read-write processor 22 and an access processor 23. The client terminal 6 is a standard personal computer with an HTML mail compliant e-mail software 61 installed. As an e-mail software 61, Outlook Express by Microsoft Corporation, for example, can be used.

In this embodiment, the image file creator 13, the HTML file creator 14 and the image file registering processor 15 correspond to the report producing means (A) of the present invention. The image file storage 21, the file read-write processor 22 and the access processor 23 correspond to the image storing means (B). The e-mail sending processor 16 and the sending mail server 3 correspond to the e-mail means (C).

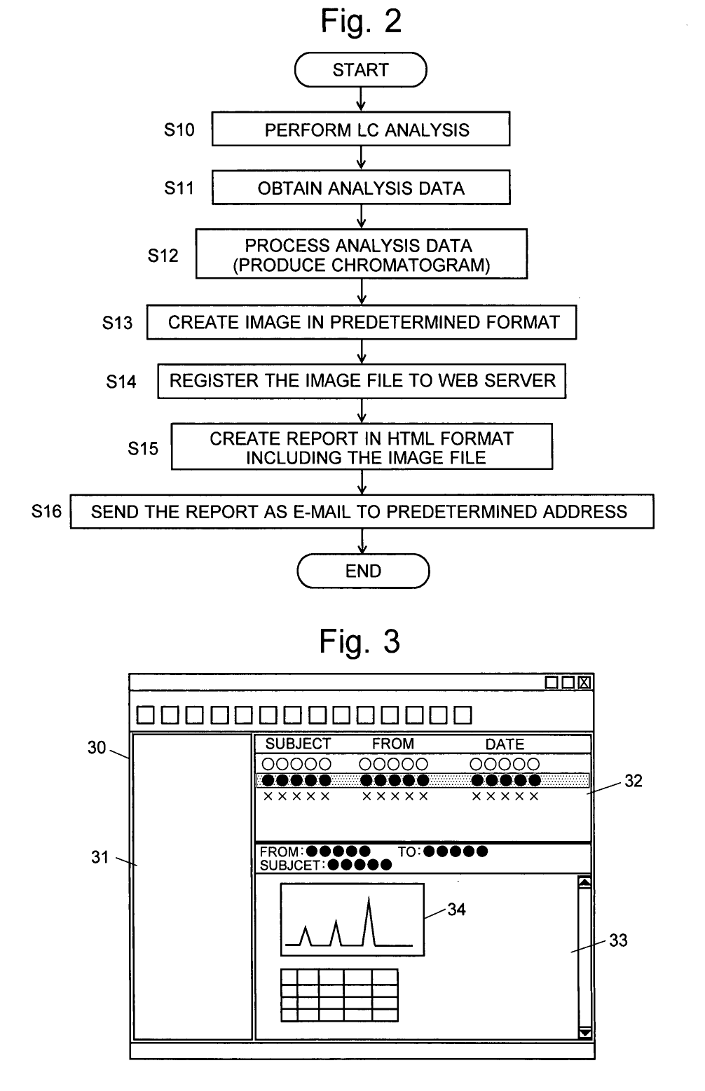

Next, operations of an LC analyzing system according to the present embodiment is described with reference to a flowchart shown in FIG. 2 which shows operations of the data processing apparatus 12.

First, the LC 11 in the analyzing component 1 performs an analysis in accordance with a predetermined analysis condition (Step S10). The data processing apparatus 12 collects the data obtained by the analysis, and produces a chromatogram for example, and then performs a data processing such as a quantitative analysis or qualitative analysis based on the chromatogram (Steps S11, S12). Specifically, the data processing apparatus 12 detects a peak or peaks by processing the waveform of the chromatogram, obtains the retention time of each peak, and determines the concentration of the constituent based on the height and area of each peak. After obtaining a chromatogram or other images by the data processing of this kind, the image file creator 13 converts the format of the chromatogram or other images and creates an image file which can be shown on standard browsers (Step S13).

After the image file is created, the image file registering processor 15 registers the image file to the web server 2 (Step S14). Specifically, the image file registering processor 15 provides a filename (“chromatograml.png” for example) for the image file in accordance with a predetermined rule, and stores the image file in a predetermined folder (“img” folder for example) on the image file storage 21 via the file read-write processor 22. The HTML file creator 14 creates a report in HTML format that contains the image file (i.e. the image is embedded in the document) as a result of the LC analysis (Step S1 5). In this HTML document, the image file is embedded as information of a destination in the image file storage 21 in the web server 2, that is, linked address.

The e-mail sending processor 16 creates an e-mail (HTML mail) which contains the report in the HTML format created in Step 15 and sends the e-mail to a predetermined e-mail address (Step S16). This e-mail is sent to the sending mail server 3 via the intranet 4, and is retained temporarily. The sending mail server 3 specifies the destination of the e-mail, and sends the e-mail to the mail server of the destination which is included in the outside internet 5. The e-mail is temporarily retained by the mail server of the destination. With that, the operations of the data processing apparatus end.

When an user downloads and opens the e-mail which is stored in the mail server by using the HTML mail compliant e-mail software 61 on the client terminal 6 at hand, the HTML mail compliant e-mail software 61 interprets the description in the HTML format and sends a download request of the image to the web server 2 in accordance with the linked address of the image. Then, the access processor 23 in the web server 2 which has received the request retrieves the pertinent image file from the image file storage 21 and sends the image to the client terminal 6 which is the source of the request.

On the client terminal 6 which has received the image file, the e-mail software 61 opens the image file and pastes it to the specified area in the opened document of the e-mail. When the e-mail software 61 is set to block automatic downloading of images, the user operates to unlock the block temporarily, and the downloading of the image file is executed and the image is pasted on the monitor. Thus, a window as shown in FIG. 3 is shown on the monitor of the client terminal 6.

In an example shown in FIG. 3, in a window 30 which appears when the e-mail software 61 is started, a folder list window 31 which shows the list of folders for storing e-mails, an e-mail list window 32 which shows the list of e-mails stored in an inbox folder for example and a preview window 33 which shows the content of an e-mail which is specified in the e-mail list window 32 are placed. When a received e-mail is specified in the e-mail list window 32, the content of the e-mail in which the image 34 such as a chromatogram is shown in the preview window 33. Consequently, the user can check the detailed analysis result, i.e. the report on a client terminal 6 at hand.

Although in the embodiment described previously, image data such as a chromatogram is registered as an image file of PNG format, other file formats can also be used. For example, the format of the image can be a vector image format in place of a bitmap (or raster) image format such as PNG, GIF and JPEG. Specifically, it is possible to use SVG (Scalable Vector Graphics) file format written in XML. In this case, the image may not be opened on a popular HTML mail compliant e-mail software 61, but, by installing a plugin software such as SVG Viewer, which Adobe Systems Incorporated offers, on the client terminal 6, the image of an SVG file can be shown when an e-mail is opened. If the file is an SVG file, it is convenient in that the shown image of the chromatogram can easily be zoomed in or out.

It should be noted that any of the embodiments described thus far are merely examples, and may be changed, modified or expanded in various forms within the spirit and scope of the present invention as specified in the claims.

For example, in an embodiment described earlier, each of the data processing apparatus 12, the web server 2 and the sending mail server 3 are realized on different computers and are connected to the intranet 4, but the configuration can be changed and modified appropriately. For example, the data processing apparatus 12 and the web server 2 can be realized on the same computer. In addition, it is possible to send image data of an analysis result for example as a mail attachment, if needed. Furthermore, apart from the internet 5, it is possible to configure only client terminals which are connected to an intranet 4 of a company or group that can receive and open the e-mail of an analysis result report. In addition, in an embodiment described earlier, the analyzer was an LC, but other analyzers such as a gas chromatograph can be used as a matter of course.

What is claimed is:

1. A data processing system for receiving analysis data from one or plural analyzers connected to a network, for processing the analysis data and for producing an analysis result from the processed analysis data, the system comprising:
a) a report producing means for producing a report of the analysis result as an HTML document;
b) an image storing means for storing an image or images included in the HTML document and for providing the image or images responsive to an access via the network; and
c) an e-mail means for sending an e-mail of the HTML document to a predetermined address,
whereby the HTML document with the image or images can be viewed on a client terminal which has received the e-mail via the network.

2. The data processing system according to claim 1, wherein the analyzer is a chromatograph and the image is a chromatogram.

3. The data processing system according to claim 1, wherein a format of the image is a vector image format.
